(19) United States
(12) Patent Application Publication
(10) Pub. No.: US 2021/0295115 A1
(43) Pub. Date: Sep. 23, 2021

(54) METHOD AND DEVICE FOR CROSS-MODAL INFORMATION RETRIEVAL, AND STORAGE MEDIUM

(71) Applicant: SHENZHEN SENSETIME TECHNOLOGY CO., LTD., Shenzhen (CN)

(72) Inventors: Zihao WANG, Shenzhen (CN); Xihui Liu, Shenzhen (CN); Jing Shao, Shenzhen (CN); Hongsheng Li, Shenzhen (CN); Lv Sheng, Shenzhen (CN); Junjie Yan, Shenzhen (CN); Xiaogang Wang, Shenzhen (CN)

(21) Appl. No.: 17/337,776

(22) Filed: Jun. 3, 2021

Related U.S. Application Data
(63) Continuation of application No. PCT/CN2019/083636, filed on Apr. 22, 2019.

(30) Foreign Application Priority Data
Jan. 31, 2019 (CN) 201910099972.3

(51) Int. Cl. G06K 9/62

(52) U.S. Cl. CPC G06K 9/6293; G06K 9/6212; G06K 9/6215

(57) ABSTRACT

A method and device for cross-modal information retrieval, and a storage medium are provided. The method includes: acquiring first modal information and second modal information; performing feature fusion on a modal feature of the first modal information and a modal feature of the second modal information, and determining a first fused feature corresponding to the first modal information and a second fused feature corresponding to the second modal information; and determining the degree of similarity between the first modal information and the second modal information on the basis of the first fused feature and the second fused feature.

### CROSS-REFERENCE TO RELATED APPLICATIONS

The present application is a continuation of International Patent application No. PCT/CN2019/083636, filed on Apr. 22, 2019, which claims priority to Chinese Patent Application No. 201910099972.3, filed on Jan. 31, 2019. The contents of International Patent application No. PCT/CN2019/083636 and Chinese Patent Application No. 201910099972.3 are hereby incorporated by reference in their entireties.

### BACKGROUND

Along with the development of computer networks, a user may acquire a large amount of information from a network. Due to a large amount of information, the user may retrieve information of interest by inputting a text or a picture. Along with constant optimization of information retrieval technology, a cross-modal retrieval manner has emerged. In the cross-modal retrieval manner, certain modality information may be used to search for other modality information with similar semantics. For example, a text corresponding to an image may be retrieved using the image. Alternatively, an image corresponding to a text may be retrieved using the text.

### SUMMARY

The disclosure relates to the technical field of computers, and particularly to a method and device for cross-modal information retrieval, and a storage medium.

According to an aspect of the disclosure, a method for cross-modal information retrieval is provided, which includes the following operations. First modal information and second modal information are acquired. Feature fusion is performed on a modal feature of the first modal information and a modal feature of the second modal information to determine a first fused feature corresponding to the first modal information and a second fused feature corresponding to the second modal information. A similarity between the first modal information and the second modal information is determined based on the first fused feature and the second fused feature.

According to another aspect of the disclosure, a device for cross-modal information retrieval is provided, which includes an acquisition module, a fusion module and a determination module. The acquisition module may be configured to acquire first modal information and second modal information. The fusion module may be configured to perform feature fusion on a modal feature of the first modal information and a modal feature of the second modal information to determine a first fused feature corresponding to the first modal information and a second fused feature corresponding to the second modal information. The determination module may be configured to determine a similarity between the first modal information and the second modal information based on the first fused feature and the second fused feature.

According to another aspect of the disclosure, a device for cross-modal information retrieval is provided, which includes a processor and a memory configured to store instructions executable for the processor, where the processor is configured to execute the abovementioned method.

According to another aspect of the disclosure, a non-transitory computer-readable storage medium is provided, in which computer program instructions may be stored, where the computer program instructions, when being executed by a processor, enable the process to implement the abovementioned method.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a method for cross-modal information retrieval according to an embodiment of the present disclosure.

FIG. 2 is a flowchart of determining fused features according to an embodiment of the present disclosure.

FIG. 3 is a block diagram of image information including multiple image units according to an embodiment of the present disclosure.

FIG. 4 is a block diagram of a process of determining a first attention feature according to an embodiment of the present disclosure.

FIG. 5 is a block diagram of a process of determining a first fused feature according to an embodiment of the present disclosure.

FIG. 6 is a flowchart of cross-modal information retrieval according to an embodiment of the present disclosure.

FIG. 7 is a block diagram of training a cross-modal information retrieval model according to an embodiment of the present disclosure.

FIG. 8 is a block diagram of a device for cross-modal information retrieval according to an embodiment of the present disclosure.

FIG. 9 is a block diagram of a device for cross-modal information retrieval according to an exemplary embodiment of the present disclosure.

### DETAILED DESCRIPTION

Various exemplary embodiments, features and aspects of the disclosure will be described in detail below with reference to the drawings, in which the same reference numbers represent functionally the same or similar elements. Although various aspects of the embodiments are shown in the drawings, the drawings are not required to be drawn to scale unless otherwise specified.

In the embodiments of the disclosure, special term “exemplary” refers to “as an example, embodiment or description”. Herein, any “exemplarily” described embodiment may not be interpreted to be superior to or better than other embodiments.

In addition, for describing the disclosure better, many specific details are presented in the following specific implementation modes. It should be understood that those skilled in the art may implement the disclosure even without some specific details. In some examples, methods, means, components and circuits which are well known to those skilled in the art are not described in detail, so as to highlight the subject matter of the disclosure.

The following method, device, electronic device or storage medium of the embodiments of the disclosure may be applied to any scenario requiring cross-modal information retrieval, and for example, may be applied to retrieval software and information positioning. A specific application scenario is not limited in the embodiments of the disclosure, and any solution for implementing cross-modal information retrieval by use of the method provided in the embodiments of the disclosure shall fall within the scope of protection of the disclosure.

According a cross-modal information retrieval solution provided in the embodiments of the disclosure, first modal information and second modal information may be acquired respectively, and then feature fusion may be performed on a modal feature of the first modal information and a modal feature of the second modal information based on the modal feature of the first modal information and the modal feature of the second modal information to obtain a first fused feature corresponding to the first modal information and a second fused feature corresponding to the second modal information, so that the correlation between the first modal information and the second modal information may be considered. In this way, when a similarity between the first modal information and the second modal information is determined, the similarity between different modal information may be evaluated by use of the obtained two fused features, and the correlations between the different modal information may be considered, so that the cross-modal information retrieval accuracy is improved.

In related art, during cross-modal information retrieval, a similarity between a text and an image is usually determined according to feature vectors of the text and the image in the same vector space, which, however, does not take internal relation between different modal information into account. For example, nouns in the text may usually correspond to some regions in the image. For another example, quantifiers in the text may correspond to some specific objects in the image. It is apparent that an internal relation between cross-modal information is not considered in the present cross-modal information retrieval manner, resulting in inaccuracy of a cross-modal information retrieval result. In the embodiments of the disclosure, the internal relation between cross-modal information is considered, so that the accuracy of a cross-modal information retrieval process is improved. The cross-modal information retrieval solution provided in the embodiments of the disclosure will be described below in combination with the drawings in detail.

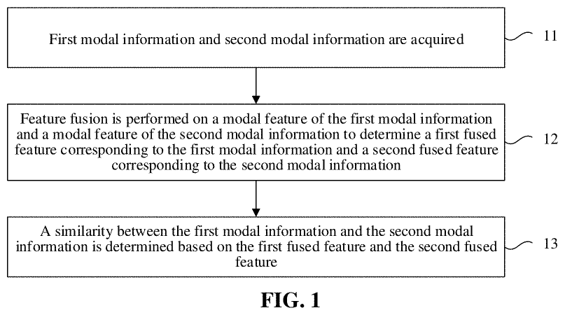

FIG. 1 is a flowchart of a method for cross-modal information retrieval according to an embodiment of the disclosure. As shown in FIG. 1, the method includes the following steps.

In block 11, first modal information and second modal information are acquired.

In the embodiment of the disclosure, a retrieval device (for example, a retrieval device like retrieval software, a retrieval platform and a retrieval server) may acquire the first modal information or the second modal information. For example, the retrieval device acquires the first modal information or second modal information transmitted by user equipment. For another example, the retrieval device acquires the first modal information or the second modal information according to user operations. The retrieval platform may also acquire the first modal information or the second modal information from a local storage or a database. Herein, the first modal information and the second modal information are information of different modalities. For example, the first modal information may include one type of modal information in text information or image information and the second modal information may include one type of modal information in the text information or the image information. Herein, the first modal information and the second modal information are not limited to the image information and the text information, and may also include voice information, video information and optical signal information, etc. Herein, the modality may be understood as a type or presentation form of the information. The first modal information and the second modal information may be information of different modalities.

In block 12, feature fusion is performed on a modal feature of the first modal information and a modal feature of the second modal information to determine a first fused feature corresponding to the first modal information and a second fused feature corresponding to the second modal information.

After the first modal information and the second modal information are acquired, feature extraction may be performed on the first modal information and the second modal information to determine the modal feature of the first modal information and the modal feature of the second modal information respectively. The modal feature of the first modal information may form a first modal feature vector, and the modal feature of the second modal information may form a second modal feature vector. Then, feature fusion may be performed on the first modal information and the second modal information according to the first modal feature vector and the second modal feature vector. When feature fusion is performed on the first modal information and the second modal information, the first modal feature vector and the second modal feature vector may be mapped to feature vectors in the same vector space at first, and then feature fusion is performed on the two feature vectors obtained by mapping. Such feature fusion manner is simple, but a matching degree between the features of the first modal information and the second modal information cannot be acquired well. The embodiment of the disclosure also provides another feature fusion manner to acquire the matching degree between the features of the first modal information and the second modal information well.

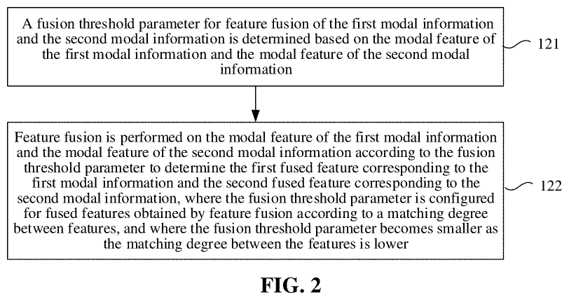

FIG. 2 is a flowchart of determining fused features according to an embodiment of the disclosure. The following steps may be included.

In block 121, a fusion threshold parameter for feature fusion of the platform, first modal information and the second modal information is determined based on the modal feature of the first modal information and the modal feature of the second modal information.

In block 122, feature fusion is performed on the modal feature of the first modal information and the modal feature of the second modal information based on fusion threshold parameter to determine the first fused feature corresponding to the first modal information and the second fused feature corresponding to the second modal information. The fusion threshold parameter is configured for fused features obtained by feature fusion according to a matching degree between features, and the fusion threshold parameter becomes smaller as the matching degree between the features is lower.

Herein, when feature fusion is performed on the modal feature of the first modal information and the modal feature of the second modal information, the fusion threshold parameter for feature fusion of the modal feature of the first modal information and the modal feature of the second modal information may be determined at first according to the modal feature of the first modal information and the modal feature of the second modal information, and then feature fusion is performed on the first modal information and the second modal information by use of the fusion threshold parameter. The fusion threshold parameter may be set according to the matching degree between the features, where the feature fusion parameter is greater if the matching degree between the features is higher. Therefore, in a feature fusion process, matched features are reserved and mismatched features are filtered, and the first fused feature corresponding to the first modal information and the second fused feature corresponding to the second modal information are determined. Setting the fusion threshold parameter in the feature fusion process enables to acquire the matching degree between the features of the first modal information and the second modal information well in a cross-modal information retrieval process.

Given that the first modal information and the second modal information may be fused better based on the fusion threshold parameter, a process of determining the fusion threshold parameter will be described below.

In a possible implementation mode, the fusion threshold parameter may include a first fusion threshold parameter and a second fusion threshold parameter. The first fusion threshold parameter may correspond to the first modal information, and the second fusion threshold parameter may correspond to the second modal information. When the fusion threshold parameter is determined, the first fusion threshold parameter and the second fusion threshold parameter may be determined respectively. When the first fusion threshold parameter is determined, a second attention feature attended by the first modal information to the second modal information may be determined according to the modal feature of the first modal information and the modal feature of the second modal information, and then the first fusion threshold parameter corresponding to the first modal information is determined according to the modal feature of the first modal information and the second attention feature. Correspondingly, when the second fusion threshold parameter is determined, a first attention feature attended by the second modal information to the first modal information may be determined according to the modal feature of the first modal information and the modal feature of the second modal information, and then the second fusion threshold parameter corresponding to the second modal information is determined according to the modal feature of the second modal information and the first attention feature.

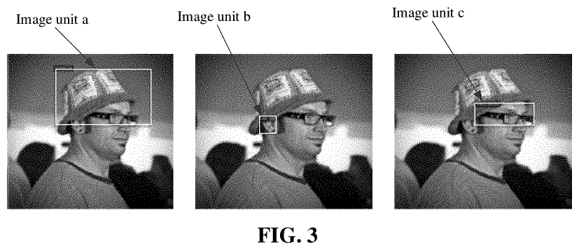

Herein, the first modal information may include at least one information unit, and correspondingly, the second modal information may include at least one information unit. Each information unit may have the same or different size, and there may be an overlap between each information unit. For example, under the condition that the first modal information or the second modal information is image information, the image information may include multiple image units, each image unit may have the same or different size, and there may be an overlap between each image unit. FIG. 3 is a block diagram of image information including multiple image units according to an embodiment of the disclosure. As shown in FIG. 3, an image unit a corresponds to a hat region of a person, an image unit b corresponds to an ear region of the person, and an image unit c corresponds to an eye region of the person. The image units a, b and c have different sizes, and there is an overlapping part between the image unit a and the image unit b.

In a possible implementation mode, when determining the second attention feature attended by the first modal information to the second modal information, the retrieval device may acquire a first modal feature of each information unit of the first modal information and acquire a second modal feature of each information unit of the second modal information. Then, an attention weight between each information unit of the first modal information and each information unit of the second modal information is determined according to the first modal feature and the second modal feature, and a second attention feature attended by each information unit of the first modal information to the second modal information is determined according to the attention weight and the second modal feature.

Correspondingly, when determining the first attention feature attended by the second modal information to the first modal information, the retrieval device may acquire the first modal feature of each information unit of the first modal information and acquire the second modal feature of each information unit of the second modal information. Then, the attention weight between each information unit of the first modal information and each information unit of the second modal information is determined according to the first modal feature and the second modal feature, and a first attention feature attended by each information unit of the second modal information to the first modal information is determined according to the attention weight and the first modal feature.

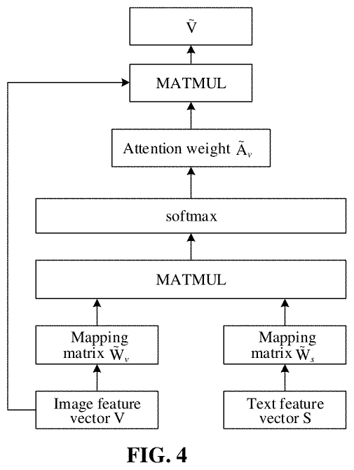

FIG. 4 is a block diagram of a process of determining a first attention feature according to an embodiment of the disclosure. For example, the first modal information is image information and the second modal information is text information. The retrieval device may acquire an image feature vector of each image unit of the image information (which is an example of the first modal feature). The image feature vector of the image unit may be represented as formula (1):

V=[v₁,v₂, . . . ,vᵢ, . . . ,v_{R}]∈ [symbol] ^{d×R}

where R is the number of the image units, d is a dimension of the image feature vector, vᵢ is the image feature vector of the i-th image unit, and [symbol] represents a real matrix. Correspondingly, the retrieval device may acquire a text feature vector of each text unit of the text information (which is an example of the second modal feature). The text feature vector of the text unit may be represented as formula (2):

S=[s₁,s₂, . . . ,sⱼ, . . . ,s_{T}]∈ [symbol] ^{d×T} (2);

where T is the number of the text units, d is a dimension of the text feature vector, and sⱼ is the text feature vector of the j-th text unit. The retrieval device may determine an association matrix between the image feature vectors and the text feature vectors according to the image feature vectors and the text feature vectors, and then determine an attention weight between each image unit of the image information and each text unit of the text information by using the association matrix. MATMUL in FIG. 4 denotes a multiplication operation.

Herein, the association matrix may be represented as formula (3):

A=(\tilde{W}ᵥV)¹(\tilde{W}ₛS) (3);

where \tilde{W}ᵥ, \tilde{W}ₛ∈ [symbol] ^{d}^{ₙ}^{×d}, and dₕ is a dimension of the matrix \tilde{W}ᵥ and \tilde{W}ₛ. \tilde{W}ᵥ is a mapping matrix for mapping an image feature to a dₕ-dimensional vector space, and \tilde{W}ₛ is a mapping matrix for mapping a text feature to the dₕ-dimensional vector space.

The attention weight between the image unit and the text unit, that is determined by use of the association matrix, may be represented as formula (4):

$${\tilde{A}}_{v} = softmax \frac{{A}^{i}}{\sqrt{{d}_{h}}} ; \qquad ( 4 )$$

where the i-th row of Ãᵥ represents an attention weight of the ith text unit for an image unit, and softmax represents a normalization exponential function.

After the attention weight between the image unit and the text unit is obtained, a first attention feature attended by each text unit to the image information may be determined according to the attention weight and the image feature. The first attention feature attended by the text unit to the image information may be represented as formula (5):

\tilde{V}=ÃᵥV^{T}∈ [symbol] ^{T×d} (5);

where the i-th row of \tilde{V} represents an attention weight of the image feature attended by the i-th text unit, i being a positive integer less than or equal to T.

Correspondingly, the attention weight between the text unit and the image unit, that is determined by use of the association matrix, may be represented as Ã_{S}. The first attention feature \tilde{S}∈ [symbol] ^{R×d} attended by the text unit to the image information may be obtained according to Ã_{S} and S, where the j-th row of \tilde{S} may represent an attention weight of the text feature attended by the j-th image unit, j being a positive integer less than or equal to R.

In the embodiment of the disclosure, after determining the first attention feature and the second attention feature, the retrieval device may determine the first fusion threshold parameter corresponding to the first modal information according to the modal feature of the first modal information and the second attention feature, and determine the second fusion threshold parameter corresponding to the second modal information according to the modal feature of the second modal information and the first attention feature. A process of determining the first fusion threshold parameter and the second fusion threshold parameter will be described below.

For example, the first modal information is image information and the second modal information is text information. The first attention feature may be \tilde{V}, and the second attention feature may be \tilde{S}. When the first fusion threshold parameter corresponding to the image information is determined, it may be determined according to the following formula (6):

gᵢ=σ(vⱼ⊙\tilde{s}ᵢ),i∈{1, . . . ,R} (6);

where ⊙ denotes the element-wise product, σ(·) denotes a sigmoid function, and gᵢ∈ [symbol] ^{d×1} denotes the fusion threshold between vᵢ and \tilde{s}ᵢ. The fusion threshold is greater if a matching degree between an image unit and the text information is higher, and thus the fusion operation may be facilitated. On the contrary, The fusion threshold value is smaller if a matching degree between an image unit and the text information is lower, and thus the fusion operation may be suppressed.

A first fusion threshold parameter corresponding to each image unit of the image information may be represented as formula (7):

Gᵥ=[g₁, . . . ,g_{R}]∈ [symbol] ^{d×R} (7);

In the same manner, a second fusion threshold parameter corresponding to each text unit of the text information may be obtained as formula (8):

Hₛ=[h₁, . . . ,h_{R}]∈ [symbol] ^{d×T} (8);

In the embodiment of the disclosure, after determining the fusion threshold parameter, the retrieval device may perform feature fusion on the first modal information and the second modal information by use of the fusion threshold parameter. A process of feature fusion between the first modal information and the second modal information will be described below.

In a possible implementation mode, the second attention feature attended by the first modal information to the second modal information may be determined according to the modal feature of the first modal information and the modal feature of the second modal information. Then, feature fusion is performed on the modal feature of the first modal information and the second attention feature by use of the fusion threshold parameter to determine the first fusion threshold parameter corresponding to the first modal information.

Herein, during feature fusion, feature fusion may be performed on the modal feature of the first modal information and the second attention feature. In this way, attention information between the first modal information and the second modal information is considered, and an internal relation between the first modal information and the second modal information also is considered, so that feature fusion of the first modal information and the second modal information is implemented better.

In a possible implementation mode, when feature fusion is performed on the modal feature of the first modal information and the second attention feature by use of the fusion threshold parameter to determine the first fused feature corresponding to the first modal information, feature fusion may first be performed on the modal feature of the first modal information and the second attention feature to obtain a first fusion result. Then, the fusion threshold parameter is applied to the first fusion result to obtain a processed first fusion result, and the first fused feature corresponding to the first modal information is determined based on the processed first fusion result and the first modal feature.

The fusion threshold parameter may include a first fusion threshold parameter and a second fusion threshold parameter. When feature fusion is performed on the modal feature of the first modal information and the second attention feature, the first fusion threshold parameter may be used, namely the first fusion threshold parameter may be caused to act on the first fusion result to determine the first fused feature.

A process of determining the first fused feature corresponding to the first modal information in the embodiment of the disclosure will be described below in combination with the drawings.

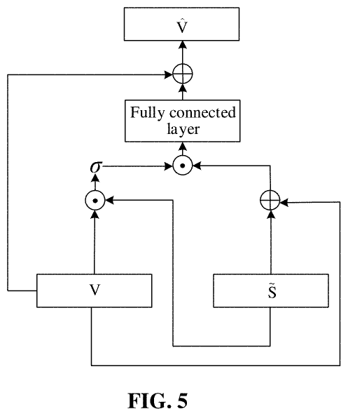

FIG. 5 is a block diagram of a process of determining a first fused feature according to an embodiment of the disclosure.

For example, the first modal information is the image information and the second modal information is the text information. The image feature vector (which is an example of the first modal feature) of each image unit of the image information is V, and a first attention feature vector formed by the first attention feature of the image information may be \tilde{V}. The text feature vector (which is an example of the second modal feature) of each text unit of the text information is S, and a second attention feature vector formed by the second attention feature of the image information may be \tilde{S}. The retrieval device may perform feature fusion on the image feature vector V and the second attention feature vector \tilde{S} to obtain a first fusion result V⊕\tilde{S}, then apply a first fusion parameter Gᵥ to V⊕\tilde{S} to obtain a processed first fusion result Gᵥ⊙⊕\tilde{S}; and obtain the first fused feature according to the processed first fusion result Gᵥ⊙V⊕\tilde{S} and the image feature vector V.

The first fused feature may be represented as formula (9):

\hat{V}=ReLU(Ŵᵥ(Gᵥ⊙(V⊕\tilde{S}))+ĥᵥ)+V (9);

where Ŵᵥ and \hat{b}ᵥ are fusion parameters corresponding to the image information, ⊙ denotes element-wise product, ⊕ is the fusion operation, and ReLU denotes a linear rectification operation.

In a possible implementation mode, the first attention feature attended by the second modal information to the first modal information may be determined according to the modal feature of the first modal information and the modal feature of the second modal information. Then feature fusion is performed on the modal feature of the second modal information and the first attention feature by use of the fusion threshold parameter to determine the second fusion threshold parameter corresponding to the second modal information.

During feature fusion, feature fusion may be performed on the modal feature of the second modal information and the first attention feature. In this way, the attention information between the first modal information and the second modal information is considered, and the internal relation between the first modal information and the second modal information is also considered, so that feature fusion of the first modal information and the second modal information is implemented better.

Herein, when feature fusion is performed on the modal feature of the second modal information and the first attention feature by use of the fusion threshold parameter to determine the second fused feature corresponding to the second modal information, feature fusion is first performed on the modal feature of the second modal information and the first attention feature to obtain a second fusion result. Then, the second fusion result is processed by using the fusion threshold parameter to obtain a processed second fusion result, and the second fused feature corresponding to the second modal information is determined based on the processed second fusion result and the second modal feature.

Herein, when feature fusion is performed on the modal feature of the first modal information and the second attention feature, the second fusion threshold parameter may be used, namely the second fusion threshold parameter may be applied to the second fusion result to determine the second fused feature.

The process of determining the second fused feature is similar to the process of determining the first fused feature and will not be elaborated herein. For example, the second modal information is the text information, and a second fused feature vector formed by the second fused feature may be represented as formula (10):

Ŝ=ReLU(Ŵₛ(Hₛ⊙(S⊕\tilde{V}))+\hat{b}ₛ)+S (10);

where Ŵₛ and \hat{b}ₛ are fusion parameters corresponding to the text information, ⊙ denotes element-wise product, ⊕ denotes the fusion operation, and ReLU denotes the linear rectification operation.

In block 13, a similarity between the first modal information and the second modal information is determined based on the first fused feature and the second fused feature.

In the embodiment of the disclosure, the retrieval device may determine the similarity between the first modal information and the second modal information according to the first fused feature vector formed by the first fused feature and the second fused feature vector formed by the second fused feature. For example, feature fusion operation may be performed on the first fused feature vector and the second fused feature vector, or, a matching operation and the like may be performed on the first fused feature vector and the second fused feature vector, so as to determine the similarity between the first modal information and the second modal information. For obtaining a more accurate similarity, the embodiment of the disclosure also provides a manner for determining the similarity between the first modal information and the second modal information. A process of determining the similarity in the embodiment of the disclosure will be described below.

In a possible implementation mode, when the similarity between the first modal information and the second modal information is determined, first attention information of the first fused feature may be acquired, and second attention information of the second fused feature may be acquired. Then, the similarity between the first modal information and the second modal information is determined based on the first attention information of the first fused feature and the second attention information of the second fused feature.

For example, under the condition that the first modal information is the image information, the first fused feature vector \tilde{V} of the image information corresponds to R image units. When the first attention information is determined according to the first fused feature vector, attention information of different image units may be extracted by use of multiple attention branches. For example, there are M attention branches, and a processing process of each attention branch is represented as formula (11):

$${A}_{v}^{* ( i )} = softmax ( \frac{{W}_{v}^{* ( i )} \hat{v}}{\sqrt{d}} ) ; \qquad ( 11 )$$

where Wᵥ*^{(t)} denotes a linear mapping parameter, i∈{1, . . . , M} represents the i-th attention branch, Aᵥ*⁽ⁱ⁾ represents the attention information for R image units from the i-th attention branch, softmax represents a normalization exponential function, and 1/\sqrt{d} represents a weight parameter, which is capable of controlling a magnitude of the attention information to ensure that the obtained attention information is in a proper magnitude range.

Then, the attention information from each of the M attention branches may be aggregated, and the aggregated attention information is averaged to obtain final first attention information of the first fused feature.

The first attention information may be represented as formula (12):

\hat{v}=SAM(\hat{V})=Σᵢ₌₁^{M}Aᵥ*⁽ⁱ⁾\hat{V}^{T} (12).

Correspondingly, the second attention information may be ŝ.

The similarity between the first modal information and the second modal information may be represented as formula (13):

m=ŝ^{T}\hat{v} (13);

where m is within a range between 0 and 1, 1 represents that the first modal information and the second modal information are matched, and 0 represents that the first modal information and the second modal information are mismatched. The matching degree of the first modal information and the second modal information may be determined according to a distance between m and 0 or 1.

In the abovementioned cross-modal information retrieval manner, considering the internal relation between the different modal information, the similarity between the different modal information is determined by performing feature fusion on the different modal information, so that the cross-modal information retrieval accuracy is improved.

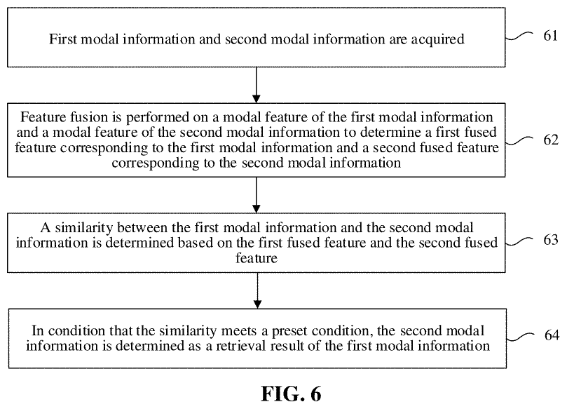

FIG. 6 is a flowchart of cross-modal information retrieval according to an embodiment of the disclosure. The first modal information may be information to be retrieved of a first modality, and the second modal information may be pre-stored information of a second modality. The method for cross-modal information retrieval may include the following steps.

In block 61, first modal information and second modal information are acquired.

In block 62, feature fusion is performed on a modal feature of the first modal information and a modal feature of the second modal information to determine a first fused feature corresponding to the first modal information and a second fused feature corresponding to the second modal information.

In block 63, a similarity between the first modal information and the second modal information is determined based on the first fused feature and the second fused feature.

In block 64, under the condition that the similarity meets a preset condition, the second modal information is determined as a retrieval result of the first modal information.

Herein, a retrieval device may acquire the first modal information input by a user and acquire the second modal information from a local storage or a database. Responsive to determining that the similarity between the first modal information and the second modal information meets the preset condition through the above steps, the second modal information may be determined as the retrieval result of the first modal information.

In a possible implementation mode, there are multiple pieces of second modal information. When the second modal information is determined as the retrieval result of the first modal information, the multiple pieces of second modal information may be sequenced according to a similarity between the first modal information and each piece of second modal information to obtain a sequencing result. The second modal information that the similarity meets the preset condition may be determined according to the sequencing result of the second modal information, and the second modal information that the similarity meets the preset condition is determined as the retrieval result of the first modal information.

The preset condition includes any one of the following conditions.

The similarity is greater than a preset value; and a rank of the similarity sequenced from low to high is higher than a preset rank.

For example, when the second modal information is determined as the retrieval result of the first modal information, if the similarity between the first modal information and second modal information, the second modal information is determined as the retrieval result of the first modal information. Or, when the second modal information is determined as the retrieval result of the first modal information, the multiple pieces of second modal information may be sequenced according to the similarity between the first modal information and each piece of second modal information and according to the similarity sequence from large to small to obtain the sequencing result, and then the second modal information of which the rank is higher than the preset rank is determined as the retrieval result of the first modal information according to the sequencing result. For example, the second modal information with the highest rank is determined as the retrieval result of the first modal information, namely the second modal information corresponding to the highest similarity may be determined as the retrieval result of the first modal information. Herein, there may be one or more retrieval results.

After the second modal information is determined as the retrieval result of the first modal information, the retrieval result may be output to a user side. For example, the retrieval result may be sent to the user side, or, the retrieval result is displayed on a display interface.

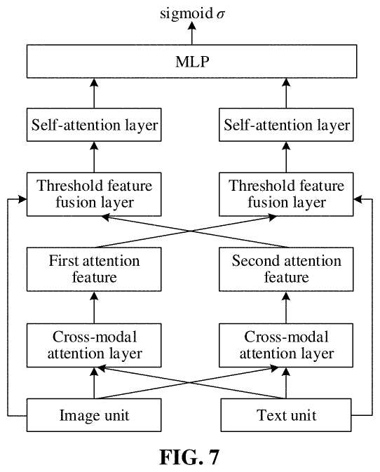

FIG. 7 is a block diagram of a training process of a cross-modal information retrieval modal according to an embodiment of the disclosure. The first modal information may be training sample information of the first modality, the second modal information may be training sample information of the second modality, and each piece of the training sample information of the first modality and each piece of the training sample information of the second modality form a training sample pair.

In the training process, each training sample pair may be input to the cross-modal information retrieval model. For example, the training sample pair is an image-text pair. An image sample and text sample in the image-text pair may be input to the cross-modal information retrieval model respectively, and modal features of the image sample and modal features of the text sample are extracted by use of the cross-modal information retrieval model. Or, an image feature of the image sample and a text feature of the text sample are input to the cross-modal information retrieval model. Then, the first attention feature \tilde{V} and second attention information \tilde{S} co-attended by both the first modal information and the second modal information may be determined by use of a cross-modal attention layer of the cross-modal information retrieval model, and feature fusion is performed on the first modal information and the second modal information by use of a threshold feature fusion layer to obtain the first fused feature \tilde{V} corresponding to the first modal information and the second fused feature ŝ corresponding to the second modal information. Next, the first attention information \hat{v} self-attended by the first fused feature \tilde{V} and the second attention information ŝ self-attended by the second fused feature are determined by use of the self-attention layer. Finally, the similarity m between the first modal information and the second modal information is output by using a Multi-Layer Perceptron (MLP) and sigmoid function (sigmoid σ).

Herein, the training sample pair may include a positive sample pair and a negative sample pair. In the process of training the cross-modal information retrieval model, loss of the cross-modal information retrieval model may be obtained by use of a loss function, so as to adjust a parameter of the cross-modal information retrieval model according to the obtained loss.

In a possible implementation mode, a similarity of each training sample pair may be acquired, then the loss in the feature fusion of the first modal information and the second modal information is determined according to the similarity of the positive sample pair with a highest modal information matching degree in the positive sample pairs and the similarity of the negative sample pair with a lowest matching degree in the negative sample pairs. The model parameters of the cross-modal information retrieval model adopted for the feature fusion of the first modal information and the second modal information are adjusted according to the loss. In the implementation mode, the loss in the training process is determined according to the similarity of the positive sample pair with the highest matching degree and the similarity of the negative sample pair with the lowest matching degree, so that the cross-modal information retrieval accuracy of the cross-modal information retrieval model is improved.

The loss of the cross-modal information retrieval model may be determined according to the following formula (14):

$${ℒ}_{B C E - h} ( ℒ , ) = log ( m ( ℒ , ) ) + [ log ( 1 - m ( ℒ , {'}^{} ) ) ] + log ( m ( ℒ , ) ) + {max}_{{ℒ}^{′}} [ log ( 1 - m ( {ℒ}^{′} , ) ) ] ; \qquad ( 14 )$$

where [symbol] _{BCE-h}( [symbol] , [symbol] ) is the calculated loss, m( [symbol] , [symbol] ) represents the similarity between the sample pairs, ( [symbol] , [symbol] ) is a group of positive sample pairs, and ( [symbol] , [symbol] ) and ( [symbol] , [symbol] ) are respective negative sample pairs.

Through the process of training the cross-modal information retrieval model, the loss in the training process is determined by use of the similarity of the positive sample pair with the highest matching degree and the similarity of the negative sample pair with the lowest matching degree, so that the accuracy that cross-modal information retrieval model retrieves the cross-modal information is improved.

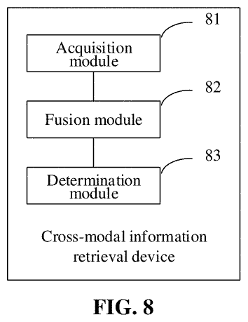

FIG. 8 is a block diagram of a device for cross-modal information retrieval according to an embodiment of the disclosure. As shown in FIG. 8, the device for cross-modal information retrieval includes an acquisition module 81, a fusion module 82 and a determination module 83.

The acquisition module 81 is configured to acquire first modal information and second modal information.

The fusion module 82 is configured to perform feature fusion on a modal feature of the first modal information and a modal feature of the second modal information to determine a first fused feature corresponding to the first modal information and a second fused feature corresponding to the second modal information.

The determination module 83 is configured to determine a similarity between the first modal information and the second modal information based on the first fused feature and the second fused feature.

In a possible implementation mode, the fusion module 82 includes a determination submodule and a fusion submodule.

The determination submodule is configured to determine a fusion threshold parameter for feature fusion of the first modal information and the second modal information based on the modal feature of the first modal information and the modal feature of the second modal information.

The fusion submodule is configured to perform feature fusion on the modal feature of the first modal information and the modal feature of the second modal information based on the fusion threshold parameter to determine the first fused feature corresponding to the first modal information and the second fused feature corresponding to the second modal information. The fusion threshold parameter is configured for fused features obtained by feature fusion according to a matching degree between features, and the fusion threshold parameter becomes smaller as the matching degree between the features is lower.

In a possible implementation mode, the determination submodule includes a second attention determination unit and a first threshold determination unit.

The second attention determination unit is configured to determine a second attention feature attended by the first modal information to the second modal information according to the modal feature of the first modal information and the modal feature of the second modal information.

The first threshold determination unit is configured to determine a first fusion threshold parameter corresponding to the first modal information according to the modal feature of the first modal information and the second attention feature.

In a possible implementation mode, the first modal information includes at least one information unit, and the second modal information includes at least one information unit. The second attention determination unit is specifically configured to:

acquire a first modal feature of each information unit of the first modal information,

acquire a second modal feature of each information unit of the second modal information,

determine an attention weight between each information unit of the first modal information and each information unit of the second modal information according to the first modal feature and the second modal feature and

determine a second attention feature attended by each information unit of the first modal information to the second modal information according to the attention weight and the second modal feature.

In a possible implementation mode, the determination submodule includes a first attention determination unit and a second threshold determination unit.

The first attention determination unit is configured to determine a first attention feature attended by the second modal information to the first modal information according to the modal feature of the first modal information and the modal feature of the second modal information.

The second threshold determination unit is configured to determine a second fusion threshold parameter corresponding to the second modal information according to the modal feature of the second modal information and the first attention feature.

In a possible implementation mode, the first modal information includes the at least one information unit, and the second modal information includes the at least one information unit. The first attention determination unit is specifically configured to:

acquire the first modal feature of each information unit of the first modal information,

acquire the second modal feature of each information unit of the second modal information,

determine the attention weight between each information unit of the first modal information and each information unit of the second modal information according to the first modal feature and the second modal feature and

determine a first attention feature attended by each information unit of the second modal information to the first modal information according to the attention weight and the first modal feature.

In a possible implementation mode, the fusion submodule includes a second attention determination unit and a first fusion unit.

The second attention determination unit is configured to determine the second attention feature attended by the first modal information to the second modal information according to the modal feature of the first modal information and the modal feature of the second modal information.

The first fusion unit is configured to perform feature fusion on the modal feature of the first modal information and the second attention feature by using the fusion threshold parameter to determine the first fused feature corresponding to the first modal information.

In a possible implementation mode, the first fusion unit is specifically configured to:

perform feature fusion on the modal feature of the first modal information and the second attention feature to obtain a first fusion result;

process the first fusion result by using the fusion threshold parameter to obtain a processed first fusion result; and

determine the first fused feature corresponding to the first modal information based on the processed first fusion result and the first modal feature.

In a possible implementation mode, the fusion submodule includes a first attention determination unit and a second fusion unit.

The first attention determination unit is configured to determine the first attention feature attended by the second modal information to the first modal information according to the modal feature of the first modal information and the modal feature of the second modal information.

The second fusion unit is configured to determine the second fused feature corresponding to the second modal information according to the modal feature of the second modal information and the first attention feature.

In a possible implementation mode, the second fusion unit is specifically configured to:

perform feature fusion on the modal feature of the second modal information and the first attention feature to obtain a second fusion result;

process the second fusion result by using the fusion threshold parameter to obtain a processed second fusion result; and

determine the second fused feature corresponding to the second modal information based on the processed second fusion result and the second modal feature.

In a possible implementation mode, the determination module 83 is specifically configured to:

determine the similarity between the first modal information and the second modal information based on first attention information of the first fused feature and second attention information of the second fused feature.

In a possible implementation mode, the first modal information is information to be retrieved of a first modality, and the second modal information is pre-stored information of a second modality; and the device further includes a retrieval result determination module.

The retrieval result determination module is configured to determine the second modal information as a retrieval result of the first modal information in condition that the similarity meets a preset condition.

In a possible implementation mode, there are multiple pieces of second modal information, and the retrieval result determination module includes a sequencing submodule, an information determination submodule and a retrieval result determination submodule.

The sequencing submodule is configured to sequence the multiple pieces of second modal information according to a similarity between the first modal information and each piece of second modal information to obtain a sequencing result.

The information determination submodule is configured to determine the second modal information that the similarity meets the preset condition according to the sequencing result.

The retrieval result determination submodule is configured to determine the second modal information that the similarity meets the preset condition as the retrieval result of the first modal information.

In a possible implementation mode, the preset condition includes any one of the following conditions.

The similarity is greater than a preset value; and a rank of the similarity sequenced from low to high is higher than a preset rank.

In a possible implementation mode, the first modal information includes one piece of modal information in text information or image information; and the second modal information includes the other piece of modal information in the text information or the image information.

In a possible implementation mode, the first modal information is training sample information of the first modality, the second modal information is training sample information of the second modality, and each piece of training sample information of the first modality and each piece of training sample information of the second modality form a training sample pair.

In a possible implementation mode, the training sample pair includes a positive sample pair and a negative sample pair. The device further includes a feedback module, configured to:

acquire a similarity of each training sample pair,

determine loss in feature fusion of the first modal information and the second modal information according to the similarity of the positive sample pair with the highest modal information matching degree in the positive sample pairs and the similarity of the negative sample pair with the lowest matching degree in the negative sample pairs and

adjust a model parameter of a cross-modal information retrieval model adopted for the feature fusion process of the first modal information and the second modal information according to the loss.

It can be understood that various method embodiments as mentioned above in the disclosure may be combined to form combined embodiments without departing from principles and logics. For saving the space, elaborations are omitted in the disclosure.

In addition, the present disclosure also provides the abovementioned device, an electronic device, a computer-readable storage medium and a program. All of them may be configured to implement any method for cross-modal information retrieval provided in the disclosure. Corresponding technical solutions and descriptions refer to the corresponding records in the method embodiments and are not be elaborated.

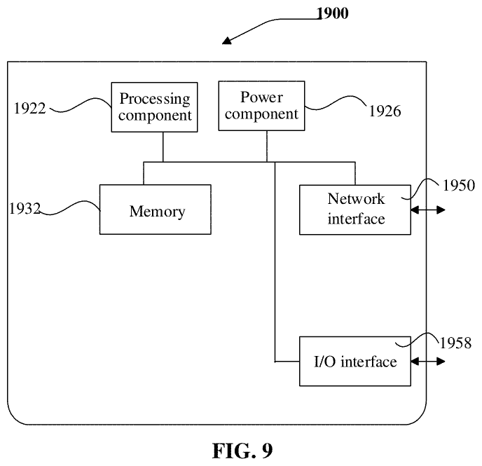

FIG. 9 is a block diagram of a device for cross-modal information retrieval 1900 according to an exemplary embodiment of the present disclosure. For example, the device 1900 may be provided as a server. Referring to FIG. 9, the device 1900 includes a processing component 1922, further including one or more processors, and memory resources represented by a memory 1932, configured to store instructions executable by the processing component 1922, for example, an application program. The application program stored in the memory 1932 may include one or more modules, each of which corresponds to a set of instructions. In addition, the processing component 1922 is configured to execute the instructions to implement the abovementioned method.

The device 1900 may further include a power component 1926 configured to perform power management of the device 1900, a wired or wireless network interface 1950 configured to connect the device 1900 to a network, and an Input/Output (I/O) interface 1958. The device 1900 may operate based on an operating system stored in the memory 1932, for example, Windows Server™, Mac OS X™, Unix™, Linux™, FreeBSD™ or the like.

In an exemplary embodiment, a non-transitory computer-readable storage medium is also provided, which includes, for example a memory 1932 including computer program instructions. The computer program instructions may be executed by the processing component 1922 of the device 1900 to implement the abovementioned method.

The present disclosure may be a system, a method and/or a computer program product. The computer program product may include a computer-readable storage medium, which stores computer-readable program instructions configured to enable a processor to implement various aspects of the present disclosure.

The computer-readable storage medium may be a tangible device capable of retaining and storing instructions used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a Read-Only Memory (ROM), an Erasable Programmable ROM (EPROM) (or a flash memory), a Static RAM (SRAM), a Compact Disc Read-Only Memory (CD-ROM), a Digital Video Disk (DVD), a memory stick, a floppy disk, a mechanical coding device, a punched card or in-slot raised structure with instructions stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instructions described in the disclosure may be downloaded from the computer-readable storage medium to each computing/processing device or downloaded to an external computer or an external storage device through a network such as the Internet, a Local Area Network (LAN), a Wide Area Network (WAN) and/or a wireless network. The network may include a copper transmission cable, optical fiber transmission, wireless transmission, a router, a firewall, a switch, a gateway computer and/or an edge server. A network adapter card or network interface in each computing/processing device receives the computer-readable program instructions from the network and forwards the computer-readable program instructions for storage in the computer-readable storage medium in each computing/processing device.

The computer program instructions configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instructions may be completely executed in a computer of a user or partially executed in the computer of the user, executed as an independent software package, executed partially in the computer of the user and partially in a remote computer, or executed completely in the remote server or a server. Under the condition that the remote computer is involved, the remote computer may be connected to the computer of the user through any type of network including an LAN or a WAN, or, may be connected to an external computer (for example, connected by an Internet service provider through the Internet). In some embodiments, an electronic circuit such as a programmable logic circuit, a Field-Programmable Gate Array (FPGA) or a Programmable Logic Array (PLA) may be customized by use of state information of a computer-readable program instruction, and the electronic circuit may execute the computer-readable program instructions, thereby implementing various aspects of the disclosure.

Various aspects of the disclosure are described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided to a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and enable the computer, the programmable data processing device and/or another device to operate in a specific manner, so that the computer-readable medium including the instructions includes a product including instructions for implementing each aspect of the function/action specified in one or more blocks of the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the functions/actions specified in one or more blocks in the flowcharts and/or the block diagrams by the instructions executed in the computer, the other programmable data processing device or the other device.

The flowcharts and block diagrams in the drawings illustrate system architectures, functions and operations of the system, method and computer program product that may be realized according to multiple embodiments of the disclosure. In this regard, each block in the flowcharts or the block diagrams may represent a module, a program segment or a part of instructions, and part of the module, which includes one or more executable instructions for implementing the specified logical functions. In some alternative implementations, the functions marked in the blocks may also be realized in a sequence different from those marked in the drawings. For example, two continuous blocks can actually be executed substantially concurrently, or may also be executed in a reverse order sometimes, which depends upon the functions involved. It is further to be noted that each block in the block diagrams and/or the flowcharts and a combination of the blocks in the block diagrams and/or the flowcharts can be implemented by a dedicated hardware-based system for implementing specified functions or operations, or by a combination of dedicated hardware and computer instructions.

The forgoing has described each embodiment of the disclosure, which are exemplary but are not intended to be exhaustive, and also are not limited to each embodiment disclosed. Many modifications and variations are apparent to those of ordinary skill in the art without departing from the scope and spirit of each described embodiment of the disclosure. The terms used herein are selected to explain the principle and practical application of each embodiment or technical improvements in the technologies in the market best or enable others of ordinary skill in the art to understand each embodiment disclosed herein.

1. A method for cross-modal information retrieval, comprising:
acquiring first modal information and second modal information;
performing feature fusion on a modal feature of the first modal information and a modal feature of the second modal information to determine a first fused feature corresponding to the first modal information and a second fused feature corresponding to the second modal information; and
determining a similarity between the first modal information and the second modal information based on the first fused feature and the second fused feature.

2. The method of claim 1, wherein performing feature fusion on the modal feature of the first modal information and the modal feature of the second modal information to determine the first fused feature corresponding to the first modal information and the second fused feature corresponding to the second modal information comprises:
determining, based on the modal feature of the first modal information and the modal feature of the second modal information, a fusion threshold parameter for feature fusion of the first modal information and the second modal information; and
performing feature fusion on the modal feature of the first modal information and the modal feature of the second modal information based on the fusion threshold parameter to determine the first fused feature corresponding to the first modal information and the second fused feature corresponding to the second modal information, wherein the fusion threshold parameter is configured for fused features obtained by feature fusion according to a matching degree between features, and the fusion threshold parameter becomes smaller as the matching degree between the features is lower.

3. The method of claim 2, wherein determining, based on the modal feature of the first modal information and the modal feature of the second modal information, the fusion threshold parameter for feature fusion of the first modal information and the second modal information comprises:
determining a second attention feature attended by the first modal information to the second modal information according to the modal feature of the first modal information and the modal feature of the second modal information; and
determining a first fusion threshold parameter corresponding to the first modal information according to the modal feature of the first modal information and the second attention feature.

4. The method of claim 3, wherein the first modal information comprises at least one information unit, and the second modal information comprises at least one information unit; and
wherein determining the second attention feature attended by the first modal information to the second modal information comprises:
acquiring a first modal feature of each of the at least one information unit of the first modal information;
acquiring a second modal feature of each of the at least one information unit of the second modal information;
determine an attention weight between each information unit of the first modal information and each information unit of the second modal information according to the first modal feature and the second modal feature; and
determining a second attention feature attended by each information unit of the first modal information to the second modal information according to the attention weight and the second modal feature.

5. The method of claim 2, wherein determining, based on the modal feature of the first modal information and the modal feature of the second modal information, the fusion threshold parameter for feature fusion of the first modal information and the second modal information comprises:
determining a first attention feature attended by the second modal information to the first modal information according to the modal feature of the first modal information and the modal feature of the second modal information; and
determining a second fusion threshold parameter corresponding to the second modal information according to the modal feature of the second modal information and the first attention feature.

6. The method of claim 5, wherein the first modal information comprises at least one information unit, and the second modal information comprises at least one information unit; and wherein determining the first attention feature attended by the second modal information to the first modal information according to the modal feature of the first modal information and the modal feature of the second modal information comprises:
acquiring a first modal feature of each of the at least one information unit of the first modal information;
acquiring a second modal feature of each of the at least one information unit of the second modal information;
determining an attention weight between each information unit of the first modal information and each information unit of the second modal information according to the first modal feature and the second modal feature; and
determining a first attention feature attended by each information unit of the second modal information to the first modal information according to the attention weight and the first modal feature.

7. The method of claim 2, wherein determining the first fused feature corresponding to the first modal information comprises:
determining a second attention feature attended by the first modal information to the second modal information according to the modal feature of the first modal information and the modal feature of the second modal information; and
performing feature fusion on the modal feature of the first modal information and the second attention feature by using the fusion threshold parameter to determine the first fused feature corresponding to the first modal information.

8. The method of claim 7, wherein performing feature fusion on the modal feature of the first modal information and the second attention feature by using the fusion threshold parameter to determine the first fused feature corresponding to the first modal information comprises:
performing feature fusion on the modal feature of the first modal information and the second attention feature to obtain a first fusion result;
processing, by using the fusion threshold parameter, the first fusion result to obtain a processed first fusion result; and
determining the first fused feature corresponding to the first modal information based on the processed first fusion result and a first modal feature.

9. The method of claim 2, wherein determining the second fused feature corresponding to the second modal information comprises:
determining a first attention feature attended by the second modal information to the first modal information according to the modal feature of the first modal information and the modal feature of the second modal information; and
determining the second fused feature corresponding to the second modal information according to the modal feature of the second modal information and the first attention feature.

10. The method of claim 9, wherein determining the second fused feature corresponding to the second modal information according to the modal feature of the second modal information and the first attention feature comprises:
performing feature fusion on the modal feature of the second modal information and the first attention feature to obtain a second fusion result;
processing, by using the fusion threshold parameter, the second fusion result to obtain a processed second fusion result; and
determining the second fused feature corresponding to the second modal information based on the processed second fusion result and a second modal feature.

11. The method of claim 1, wherein determining the similarity between the first modal information and the second modal information based on the first fused feature and the second fused feature comprises:
determining the similarity between the first modal information and the second modal information based on first attention information of the first fused feature and second attention information of the second fused feature.

12. The method of claim 1, wherein the first modal information comprises information to be retrieved of a first modality, and the second modal information comprises pre-stored information of a second modality; and wherein the method further comprises:
determining the second modal information as a retrieval result of the first modal information in condition that the similarity meets a preset condition.

13. The method of claim 12, wherein the second modal information comprises multiple pieces of second modal information, and wherein determining the second modal information as the retrieval result of the first modal information in condition that the similarity meets the preset condition comprises:
sequencing the multiple pieces of second modal information according to a similarity between the first modal information and each of the multiple pieces of second modal information to obtain a sequencing result;
determining, according to the sequencing result, a second modal information that the similarity meets the preset condition; and
determining the second modal information that the similarity meets the preset condition as the retrieval result of the first modal information.

14. The method of claim 13, wherein the preset condition comprises any one of the following conditions that:
the similarity is greater than a preset value; and a rank of the similarity sequenced from low to high is higher than a preset rank.

15. The method of claim 1, wherein the first modal information comprises one piece of modal information in text information or image information; and the second modal information comprises the other piece of modal information in the text information or the image information.

16. The method of claim 1, wherein the first modal information comprises training sample information of a first modality, the second modal information comprises training sample information of a second modality, and wherein each piece of the training sample information of the first modality and each piece of the training sample information of the second modality form a training sample pair.

17. The method of claim 16, wherein the training sample pair comprises a positive sample pair and a negative sample pair; and wherein the method further comprises:
acquiring a similarity of each training sample pair,
determining a loss in feature fusion of the first modal information and the second modal information according to a similarity of a positive sample pair with a highest matching degree of modal information in positive sample pairs and a similarity of a negative sample pair with a lowest matching degree in negative sample pairs, and
adjusting, according to the loss, a model parameter of a cross-modal information retrieval model that is adopted for the feature fusion of the first modal information and the second modal information.

18. A device for cross-modal information retrieval, comprising:
a processor; and
a memory, configured to store instructions executable by the processor,
wherein the processor is configured to execute the executable instructions stored in the memory to carry out:
acquiring first modal information and second modal information;
performing feature fusion on a modal feature of the first modal information and a modal feature of the second modal information to determine a first fused feature corresponding to the first modal information and a second fused feature corresponding to the second modal information; and
determining a similarity between the first modal information and the second modal information based on the first fused feature and the second fused feature.

19. The device of claim 18, wherein the processor is further configured to execute the executable instructions stored in the memory to carry out:
determining, based on the modal feature of the first modal information and the modal feature of the second modal information, a fusion threshold parameter for feature fusion of the first modal information and the second modal information; and
performing feature fusion on the modal feature of the first modal information and the modal feature of the second modal information based on the fusion threshold parameter to determine the first fused feature corresponding to the first modal information and the second fused feature corresponding to the second modal information, wherein the fusion threshold parameter is configured for fused features obtained by feature fusion according to a matching degree between features, and the fusion threshold parameter becomes smaller as the matching degree between the features is lower.

20. A non-transitory computer-readable storage medium, having stored therein computer program instructions that, when being executed by a processor, cause the processor to carry out:
acquiring first modal information and second modal information;
performing feature fusion on a modal feature of the first modal information and a modal feature of the second modal information to determine a first fused feature corresponding to the first modal information and a second fused feature corresponding to the second modal information; and
determining a similarity between the first modal information and the second modal information based on the first fused feature and the second fused feature.
